(19) United States
(12) Patent Application Publication
(10) Pub. No.: US 2007/0278437 A1
(43) Pub. Date: Dec. 6, 2007

(54) Valve control method

(76) Inventor: Yuji Takaiwa, Yokohama-shi (JP)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/805,287

(22) Filed: May 22, 2007

(30) Foreign Application Priority Data
May 31, 2006 (JP) 2006-152744

(51) Int. Cl. F16K 31/02

(52) U.S. Cl. 251/129.11

(57) ABSTRACT

According to one embodiment, in a method of controlling a valve, a valve body is moved by a first distance toward an open position at a start of the operation, the first distance being longer than a distance corresponding to maximal compression of a sealing member, and then, moved in a closing direction as far as a fully closed position where the sealing member is depressed by the valve body to be maximally compressed, and setting the fully closed position as an initialized position. The valve body is moved with the initialized position as a reference, to a normal closed position by a second distance in the opening direction, the second distance being shorter than the distance corresponding to maximal compression, or to a normal open position by a third distance in the opening direction to open the passage, the third distance being longer than the first distance.

### CROSS-REFERENCE TO RELATED APPLICATIONS

This application is based upon and claims the benefit of priority from the Japanese Patent Application No. 2006-152744, filed May 31, 2006, the entire contents of which are incorporated herein by reference.

### BACKGROUND

1. Field

One embodiment of the present invention relates to a valve control method for controlling a valve that opens or closes an air passage, etc.

2. Description of the Related Art

A device for controlling the flow of a fluid, for example a flow rate control device, has a valve for opening or closing a passage, and opens or closes the valve according to the operating state of the device, thereby controlling a fluid passing through the passage. Such a valve includes: a case in which a passage is defined; a valve body disposed in the case to be movable between a closed position where the passage is closed and an open position where the passage is opened; and a driving section, such as a motor, which moves the valve body. The valve body is supported by a bearing. Such a valve having a position sensor uses the position sensor to detect the position of the valve body and moves the valve body to a closed or open position.

On the other hand, in order to reduce the size and cost of the valve, valves having no position sensors have been proposed. Such a valve initializes the position of the valve body at the start of an operation and then, with the initialized position as a reference position, determines the closed and open positions for the valve body. For instance, in the case of a valve disclosed in Jpn. Pat. Appln. KOKAI Publication No. 2005-265104, the position of the valve body is controlled by virtue of a controlled closed position for initialization in which the valve body is slightly moved in the open direction after moved to the fully closed position.

However, in the case where the valve body has been left depressed in the closing direction, and the valve is operated such that the valve body is first closed in order to initialize the valve, the valve body may mechanically lock due to distortion or the like of a bearing. Such mechanical locking of the valve body may lead to operation failure of the valve, which may make it difficult to control the fluid.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a circulation system of a fuel cell device according to an embodiment of the present invention;

FIG. 2 is an exemplary sectional view of an intake control valve provided in the fuel cell device;

FIG. 3 is an exemplary sectional view of the intake control valve in an open state;

FIGS. 4A, 4B, and 4C are exemplary sectional views of the intake control valve, showing positional relations between an O-ring and a valve body; and

FIG. 5 is an exemplary chart showing the control sequences of the intake control valve.

### DETAILED DESCRIPTION

Various embodiments according to the invention will be described hereinafter with reference to the accompanying drawings. In general, according to one embodiment of the invention, a method of controlling a valve which comprises: an elastically deformable sealing member arranged along a circumference of a passage opening and having a predetermined maximal compression; a valve body arranged to be movable between a closed position where the valve body comes into contact with the sealing member so as to compress it and close the passage opening together with the sealing member, and an open position where the valve body is separated from the sealing member and opens the passage opening; a driving section having a stepping motor which moves the valve body, the method comprises: moving the valve body by the stepping motor by a first distance toward the open position at a start of the operation of the valve, the first distance being longer than a distance corresponding to maximal compression of the sealing member; moving the valve body by the stepping motor in a closing direction as far as a fully closed position where the sealing member is depressed by the valve body so as to be maximally compressed, and setting the fully closed position as an initialized position; and moving the valve body by the stepping motor, with the initialized position as a reference, to a normal closed position, separate from the initialized position by a second distance in the opening direction, the second distance being shorter than the distance corresponding to maximal compression, or to a normal open position, separate from the initialized position by a third distance in the opening direction, and thereby opening the passage, the third distance being longer than the first distance.

Referring to the accompanying drawings, there will be described in detail a fuel cell device that has a valve controlled by a valve control method according to an embodiment of the present invention.

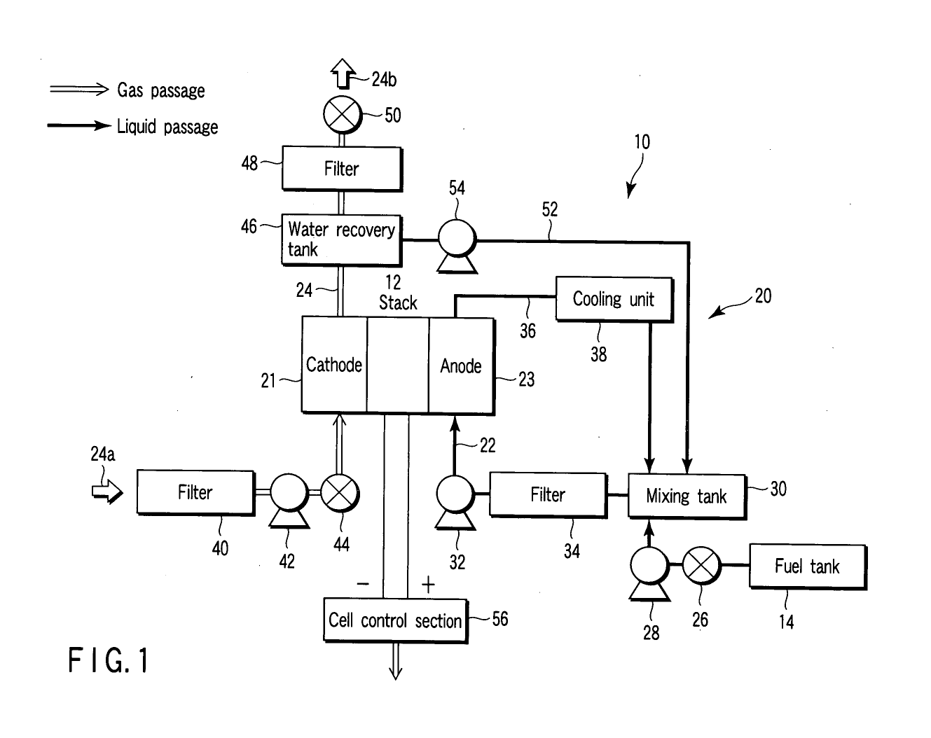

FIG. 1 shows the configuration of a circulatory system of the fuel cell device. As shown in FIG. 1, a fuel cell device 10 is configured as DMFC (Direct Methanol Fuel Cell), which uses methanol as a liquid fuel. The fuel cell device 10 comprises a DMFC stack 12 constituting an electromotive section, a fuel tank 14, and a circulatory system 20 for supplying fuel and air to the electromotive section.

The DMFC stack 12 has a plurality of single cells arranged in layers. Each single cell includes: a cathode 21 (air electrode) and an anode 23 (fuel electrode), having the shape of a rectangular plate and formed from a catalytic layer and carbon paper; and a membrane electrode assembly (MEA) formed from a rectangular polyelectrolyte film integrally held between the cathode and the anode.

The fuel tank 14 has a sealed structure, and stores therein high concentration methanol as a liquid fuel. The fuel tank 14 may be in the form of a fuel cartridge freely detachable from the fuel cell device 10.

The circulatory system 20 includes: a liquid passage 22 by which a liquid containing fuel supplied from the fuel tank 14 is circulated through the DMFC stack 12; a gas passage 24 by which gas containing air is circulated through the DMFC stack 12; and a plurality of auxiliary devices disposed in the fuel passage and the air passage. The liquid passage 22 and the air passage 24 are defined by pipes or the like.

The auxiliary devices disposed in the liquid passage 22 include: a fuel control valve 26 connected to the output of the fuel tank 14 by piping; a fuel supply pump 28; a mixing tank 30 connected to the output of the fuel supply pump 28 by piping; a delivery pump 32 connected to the output of the mixing tank 45; and an ion filter 34 disposed between the mixing tank and the delivery pump. The output of the delivery pump 32 is connected to the anode 23 of the DMFC stack 12 via piping.

The output of the anode 23 is connected to the input of the mixing tank 30 via a piping 36 defined as a recovery passage that is part of the liquid passage 22. The piping 36 is defined as a passage, along which fluids discharged from the anode 23 of the DMFC stack 12, namely produced carbon dioxide and methanol solution not used in a chemical reaction and remaining unreacted, are returned to the mixing tank 30. Heat radiating fins are mounted around the piping 36. The heat radiating fins constitute an anode cooling section 38 for cooling methanol solution discharged from the anode 23. A cooling fan, not shown, is arranged near the heat radiating fins.

The air passage 24 includes an intake end 24a with an intake port, and an exhaust end 24b with an exhaust port. Sequentially disposed in the air passage 24 between the intake end 24a and the DMFC stack 12, are an intake filter 40, an air supply pump 42, and an intake control valve 44. The air supply pump 42 draws air into the air passage 24 via the intake end 24a, and supplies it to the cathode 21 of the DMFC stack 12. The intake filter 40 traps and removes dust, impurities, and harmful substances contained in the air drawn from the intake end 4a. The intake control valve 44 mentioned above opens or closes the gas passage 24, thereby controlling the supply of air.

Sequentially disposed in the air passage 24 between the outlet end of the DMFC stack 12 and the exhaust end 24b, are a water recovery tank 46, an exhaust filter 48, and an exhaust control valve 50. The water recovery tank 46 is connected to the input of the mixing tank 30 via a recovery passage 52 defined by piping. A water recovery pump 54 is arranged in the recovery passage 52.

Fluid (e.g., vapor and water) discharged from the output of the cathode 21 of the DMFC stack 12 is conveyed to the water recovery tank 46, where water in the fluid is recovered. The recovered water is conveyed to the mixing tank 30 via the piping 36 by the water recovery pump 54, and mixed with methanol. In addition, gas in the water recovery tank 46 is passed through the exhaust filter 48, where impurities, dust, etc., are removed, and is expelled via the exhaust control valve 50.

The DMFC stack 12, various pumps 28, 32, 42, and 54, fuel control valve 26, intake control valve 44, and exhaust control valve 50 are connected to a cell control section 56, which controls operations. Power produced by the DMFC stack 12 is supplied to external devices from the cell control section 56.

Next, the configurations of, and a method of controlling the intake control valve 44 and the exhaust control valve 50, which are disposed in the gas passage 24, will be described below. The intake control valve 44 and the exhaust control valve 50 are identical in configuration and therefore a description is given of the intake control valve 44 as a representative example.

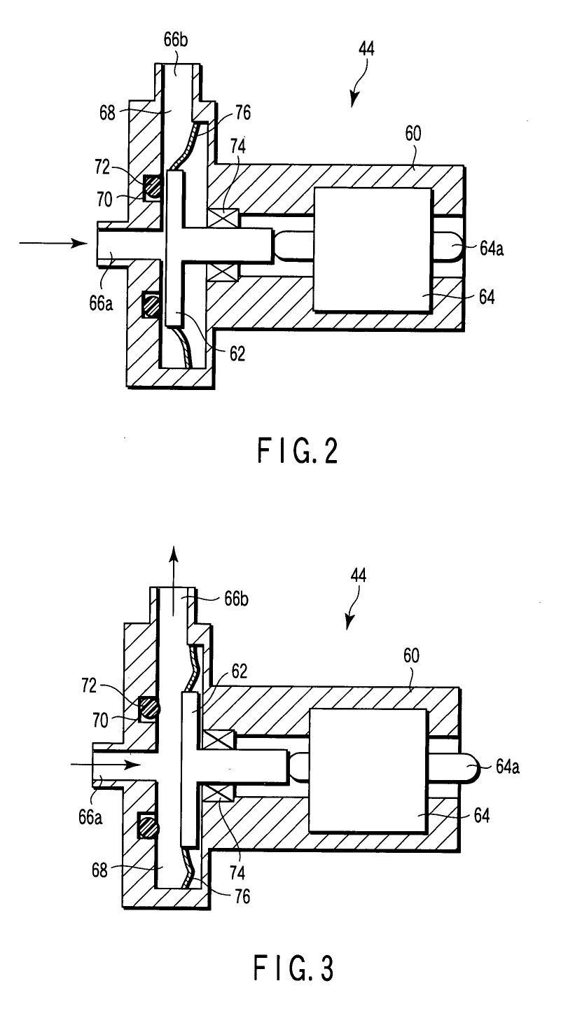

FIG. 2 shows a closed state of the intake control valve 44 whereas FIG. 3 shows an open state of the intake control valve 44. As shown in FIG. 2, the intake control valve 44 includes a hollow case 60, a valve body 62 disposed in the case, and a direct acting stepping motor 64 disposed in the case and used to move the valve body.

Formed in the case 60 are an inlet 66a and an outlet 66b, which are connected to the gas passage 24. Defined in the case 60 is a flow passage 68 through which the inlet 66a and the outlet 66b communicate. An annular accommodating groove 70 is formed in the inner surface of the case 60 around the inlet 66a Fixed in the accommodating groove 70 is an O-ring 72 functioning as a sealing member. The O-ring 72 is made of an elastic material. Part of the O-ring 72 projects into the flow passage 68 from the inner surface of the case 60.

The valve body 62 is arranged within the flow passage 68, and is supported by a bearing 74 to be freely movable. To be specific, the valve body 62 is supported to be movable between a closed position where the valve body 62 comes into contact with the O-ring 72 and thereby closes the inlet 66a as shown in FIG. 2, and an open position where the valve body 62 is apart from the O-ring and thereby opens the inlet 66a such that the inlet and the outlet 66b communicate, as shown in FIG. 3. An elastic seal 76 extends between the valve body 62 and the inner surface of the case 60. The elastic seal 76 elastically biases the valve body 62 in the direction in which the valve body is opened, and forms an airtight seal between the valve member and the bearing 74.

The direct acting stepping motor 64 serving as a driving section has a rotating shaft 64a. The rotating shaft 64a extends substantially in parallel to the direction of movement of the valve body 62 and one end thereof is in contact with the valve body 62. The direct acting stepping motor 64 rotates the shaft 64a in response to a drive signal, such as a drive pulse signal, transmitted from the cell control section 56. The rotating shaft 64a moves straight in its axial direction in synchronization with the rotation. For example, driving the direct acting stepping motor 64 in normal direction brings the rotating shaft 64a toward the valve body 62 whereas driving the direct acting stepping motor 64 in the reverse direction separates the rotating shaft 64a from the valve body 62. By moving the rotating shaft 64a toward the valve body 62 by the direct acting stepping motor 64, the valve body 62 is moved to a closed position. By moving the rotating shaft 64a in the reverse direction by the direct acting stepping motor 64, the valve body 62 is biased by the elastic seal 76 and moved to an open position together with the rotating shaft 64a.

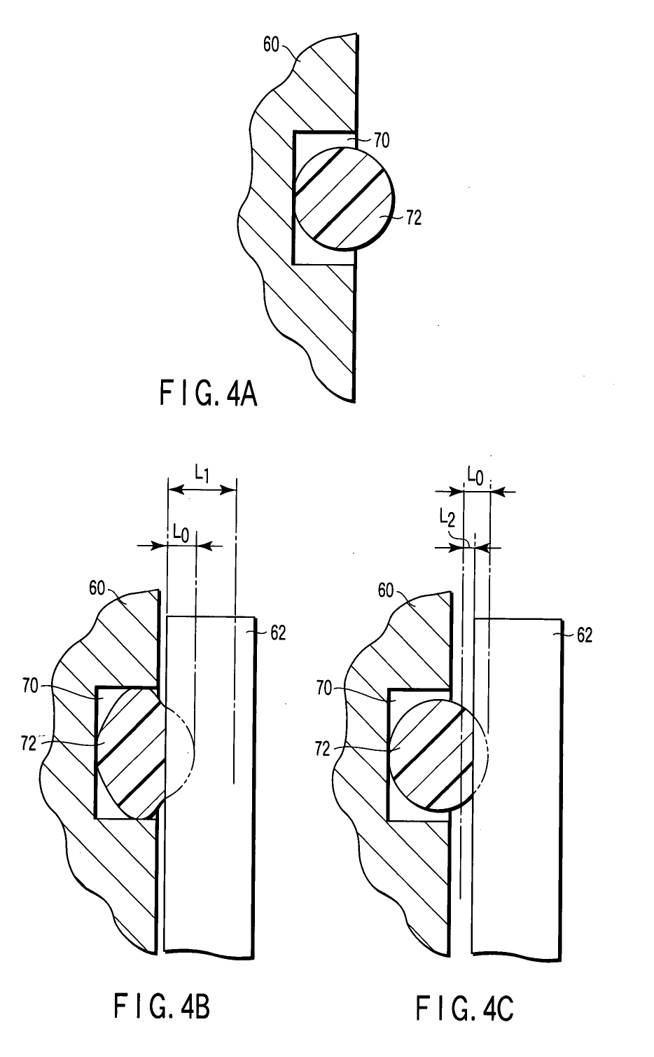

FIGS. 4A, 4B, and 4C show an opened state, a fully closed state, and a normal closed state of the intake control valve 44, respectively. As shown in FIG. 4A, where the valve body 62 is moved to an open position and separates from the O-ring 72, the O-ring is not compressed and is approximately circular in section. The closed position in which the valve body 62 is in contact with the O-ring 72 includes the fully closed position as shown in FIG. 4B, and the normal closed position as shown in FIG. 4C.

In the fully closed position, the valve body 62 is moved to the position that is immediately in front of the inner surface of the case 60 so as to approach the inner surface thereof. In this state, the O-ring 72 is depressed by the valve body 62 and is in close contact with the valve body in such a manner as to be maximally compressed in the groove 70. The distance between the edges of the O-ring 72 in maximally compressed and uncompressed states, in other words a distance corresponding to maximal compression of the O-ring, is denoted as L0.

In the normal closed position as shown in FIG. 4C, the valve body 62 is moved in the opening direction by a second distance L2 from the fully closed position. The second distance L2 is set shorter than the distance L0 corresponding to maximal degree compression. To be specific, the second distance L2 is set such that the valve body 62 and the O-ring 72 are in contact with each other and leakage of fluid from the gap between the valve body and the O-ring has a predetermined value or below.

As described below, the open position of the valve body 62 includes a normal open position, and a fully open position where the valve body 62 is moved further in the opening direction than the normal open position.

When an operation is started, the intake control valve 44 having the above-described configuration is initialized under control exerted by the cell control section 56. Based upon the position obtained by initialization, the valve body is moved to the normal closed position or the normal open position.

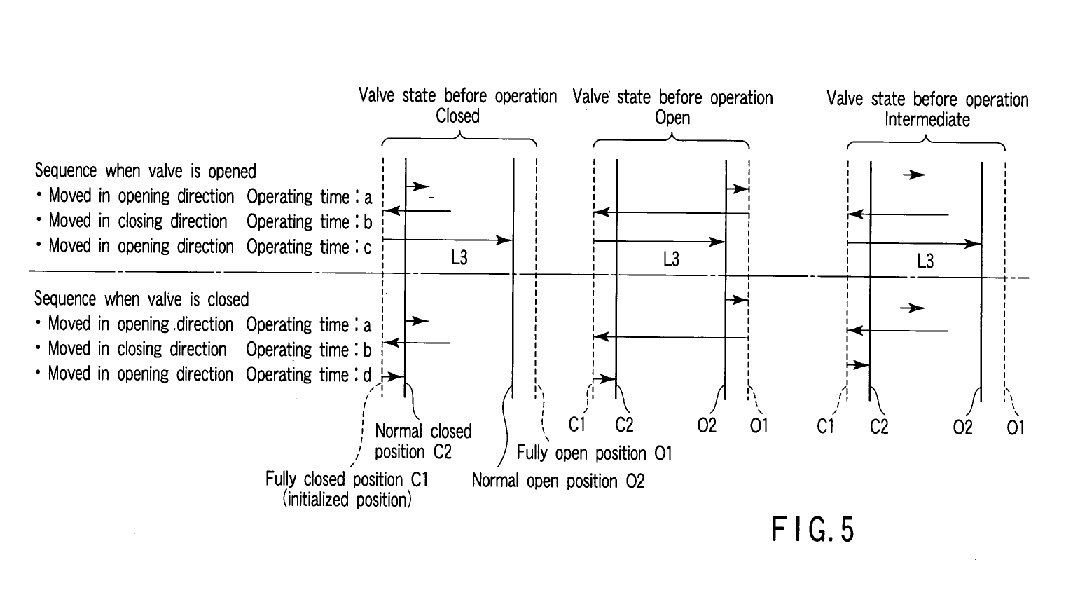

The upper portion of FIG. 5 shows the sequence when the intake control valve 44 is opened, and the lower portion thereof shows the sequence when the intake control valve 44 is closed. First, the sequence when the intake control valve 44 is opened will be described below. Regardless of the position of the valve body 62 before the operation (i.e., whether the valve body 62 is in the normal closed position C2, the normal open position O2, or a position therebetween), when the operation starts, the cell control section 56 exerts control such that, as shown in the upper portion of FIG. 5, the direct acting stepping motor 64 moves the valve body 62 toward an open position by a first distance L1 (>L0) that is longer than the distance L0 corresponding to the maximal compression of the O-ring 72. In this case, the direct acting stepping motor 64 is driven for operating time “a”, which corresponds to the first distance L1. Subsequently, the direct acting stepping motor 64 is driven for operating time “b”, such that the valve body 62 is moved in the closing direction as far as the fully closed position C1. In the fully closed position C1, the O-ring 72 is depressed by the valve body 62 until maximally compressed. The cell control section 56 then sets the fully closed position C1 as the initialized position. Thus having the initialized position as a reference, the cell control section 56 controls the position of the valve body 62 thereafter.

Incidentally, if a drive signal is further supplied to the direct acting stepping motor 64 continuously after the valve body 62 is moved to the fully closed position, the rotating shaft 64a falls out of step within the motor. Consequently, the valve body 62 is prevented from being excessively depressed in the closing direction from the fully closed position C1. Accordingly, the valve body is securely held in the fully closed position C1.

Subsequently, using the direct acting stepping motor 64, the cell control section 56 drives the rotating shaft 64a for the predetermined length of operating time “c” such that the valve body 62 is moved in the open direction from the initialized position (i.e., fully closed position C1) by a predetermined third distance L3 longer than the first distance L1. Consequently, the valve body 62 is accurately set to the normal closed position O2.

In the normal open position O2 at the start of the operation, the valve body 62 is further moved in the open direction from the normal open position by the first distance L1 by using the direct acting stepping motor 64, just as in the case described above. Consequently, the valve body 62 is further moved in the open direction from the normal open position as far as the fully open position O1. In the fully open position O1, the valve body 62 abuts on the inner surface of the case 60, so that further movement of the valve body in the opening direction is restricted. Next, the direct acting stepping motor 64 operates for only the length of operating time “b”, thereby moving the valve body 62 to the fully closed position C1 set as the initialized position. Then, the direct acting stepping motor 64 drives the rotating shaft 64a for the predetermined length of operating time “c”, thereby moving the valve body 62 in the opening direction from the fully closed position C1 by the distance L3. Thus, the valve body 62 is accurately set to the normal open position O2.

Next, the sequence when the intake control valve 44 is closed will be described. When the operation starts, the cell control section 56 exerts control such that, regardless of the position of the valve body 62 before the operation, as shown in the lower portion of FIG. 5, the direct acting stepping motor 64 moves the valve body 62 toward an open position by a first distance L1 that is longer than the distance L0 corresponding to maximal compression of the O-ring 72. In this case, the direct acting stepping motor 64 is driven only for the length of operating time “a”, which corresponds to the first distance L1. Subsequently, the direct acting stepping motor 64 operates only for the operating time “b”. Consequently, the O-ring 72 is depressed by the valve body 62 such that the valve body is moved in a closing direction as far as the fully closed position C1 where the O-ring 72 is maximally compressed. The fully closed position C1 is then set as the initialized position.

Subsequently, the cell control section 56 drives the direct acting stepping motor 64 for the length of operating time “d”, thereby moving the valve body to the normal closed position C2 that is separate from the initialized position by the second distance L2 shorter than the distance corresponding to maximal compression. Accordingly, having the fully closed position C1 as the reference, the valve body 62 is accurately set in the normal open position O2.

For each of the first, second, and third distances by which the valve 62 is moved, the cell control section 56 pre-stores the corresponding operating time of the direct acting stepping motor or the corresponding number of drive pulses of the direct acting stepping motor. The cell control section 56 inputs a drive signal to the direct acting stepping motor according to the corresponding operating time or the corresponding number of pulses, thereby moving the valve body.

The exhaust control valve 50 is also switched between the initialized position and a closed position or open position by a valve control method that is the same as the foregoing valve control method.

According to the valve control method having the configuration described above, at the start of the operation of the valve, the operation sequence begins from the opening direction regardless of the position of the valve body. This obviates the need for a position sensor for detecting the position of the valve body, and prevents operation failure which may be caused by the bearing 74 locking. Accordingly, stable initialization can be ensured. In addition, according to the foregoing valve control method, obviating the need for a position sensor decreases the size of the valve and manufacturing cost. Further, since the valve body is moved to the fully closed position and then to the normal closed position slightly shifted in the opening direction, the driving force transmission system can be prevented from mechanically locking.

As apparent from the above description, the present invention provides a valve control method whereby opening/closing of the valve can be accurately controlled without a positional sensor and the valve body can be prevented from mechanically locking.

While certain embodiments of the inventions have been described, these embodiments have been presented by way of example only, and are not intended to limit the scope of the inventions. Indeed, the novel methods and systems described herein may be embodied in a variety of forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

For example, the valve control method according to the invention can be applied not only to valves for fuel cell devices but also to valves for other fluid control devices.

What is claimed is:

1. A method of controlling a valve which comprises: an elastically deformable sealing member arranged along a circumference of a passage opening and having a predetermined maximal compression; a valve body arranged to be movable between a closed position where the valve body comes into contact with the sealing member so as to compress it and close the passage opening together with the sealing member, and an open position where the valve body is separated from the sealing member and opens the passage opening; a driving section having a stepping motor which moves the valve body, the method comprising:
moving the valve body by the stepping motor by a first distance toward the open position at a start of the operation of the valve, the first distance being longer than a distance corresponding to maximal compression of the sealing member;
moving the valve body by the stepping motor in a closing direction as far as a fully closed position where the sealing member is depressed by the valve body so as to be maximally compressed, and setting the fully closed position as an initialized position; and
moving the valve body by the stepping motor, with the initialized position as a reference, to a normal closed position, separate from the initialized position by a second distance in the opening direction, the second distance being shorter than the distance corresponding to maximal compression, or to a normal open position, separate from the initialized position by a third distance in the opening direction, and thereby opening the passage, the third distance being longer than the first distance.

2. The method according to claim 1, wherein a drive signal is input to the stepping motor by the number of pulses corresponding to the first, second, or third distance, to move the valve body.

3. The method according to claim 2, wherein the second distance is set so that leakage of fluid from a gap between the valve body and the sealing member has a predetermined value or below.

4. The method according to claim 1, wherein the second distance is set so that leakage of fluid from a gap between the valve body and the sealing member has a predetermined value or below.
